(19) United States
(12) Patent Application Publication
(10) Pub. No.: US 2006/0088078 A1
(43) Pub. Date: Apr. 27, 2006

(54) Method for determining the operating temperature of electrical devices

(75) Inventors: Juergen Gerhart, Appenweier (DE); Thomas Eggert, Karslruhe (DE)

Correspondence Address: DAVIDSON, DAVIDSON & KAPPEL, LLC, 485 SEVENTH AVENUE, 14TH FLOOR, NEW YORK, NY, 10018, US

(73) Assignee: LuK Lamellen und Kupplungsbau Beteiligungs KG, Buehl (DE)

(21) Appl. No.: 11/254,828

(22) Filed: Oct. 20, 2005

(30) Foreign Application Priority Data
Oct. 23, 2004 (DE) 10 2004 051 704.5

(51) Int. Cl. G01K 1/08

(52) U.S. Cl. 374/152; 374/163

(57) ABSTRACT

A method for determining an operating temperature of electrically operated devices in a motor vehicle by setting at least one first value of an electrical quantity describing the current flow through the device at the specified initial temperature; by measuring a second value of an electrical quantity describing the current flow through the device during one operating state of the device; and by ascertaining the operating temperature of the device using the first value, the specified initial temperature, and the second value.

This claims the benefit of German Patent Application No. 10 2004 051 704.5, filed Oct. 23, 2004 and hereby incorporated by reference herein.

### BACKGROUND

The present invention is directed to a method for determining the operating temperature of electrical devices, in particular in a motor vehicle. It is described in the context of determining the operating temperature of electric motors. However, it is applicable as well to other electrically operated devices in a motor vehicle.

From the related art, it is known to use electric motors for driving clutches and transmissions. It is especially important in this regard that the temperature of the electric motor in question be continuously controlled. The purpose of the temperature control is, inter alia, to protect the electric motors from being overloaded. This can be accomplished by outputting a warning when a specific motor temperature is reached, or by switching off the electric motor in response to an additional limiting temperature being exceeded. Thermal destruction to the motor can be prevented in this manner.

Methods are known from the related art which provide for using temperature sensors for measuring the motor temperature directly. Besides the temperature sensors mentioned, such measurements require appropriate measuring leads and inputs in the control unit.

### SUMMARY OF THE INVENTION

An object of the method according to the present invention is, therefore, to control the temperature of electrically operated devices and their ambient environment without using expensive, wear-susceptible temperature sensors.

The present invention provides a method for determining an operating temperature of an electrically operated device in a motor vehicle, comprising the steps of:
setting at least one first value of an electrical quantity describing the current flow through the device at a specified initial temperature;
measuring a second value of an electrical quantity describing the current flow through the device during one operating state of the device; and
ascertaining the operating temperature of the device using the first value, the specified initial temperature, and the second value.

The present invention is also directed a system for determining an operating temperature of electrically operated devices in a motor vehicle, having a processor unit which is set up in a way that enables at least one first value of an electrical quantity describing the current flow through the device to be set at the specified initial temperature; and a second value of an electrical quantity describing the current flow through the device to be measured during one operating state of the device; and finally, in such a way that the operating temperature of the device is ascertained using the first value, the specified initial temperature, and the second value.

### BRIEF DESCRIPTION OF THE DRAWING

FIG. 1 shows a flow chart of the method of the present invention; and

FIG. 2 shows a system according to the present invention in a motor vehicle.

### DETAILED DESCRIPTION

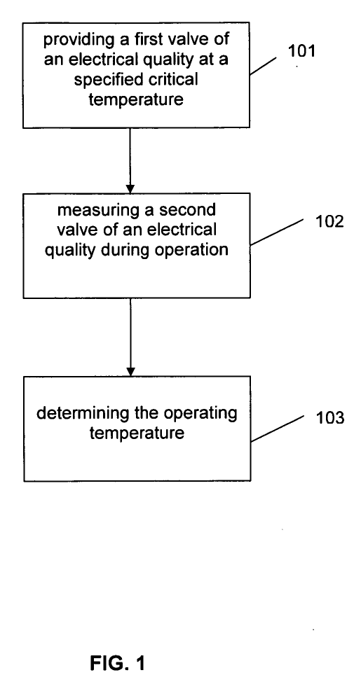

As shown in FIG. 1, in accordance with the method according to the present invention, at least one first value of an electrical quantity describing the current flow through the device is set at a specified initial temperature in step 101.

In another method step 102, a second value of an electrical quantity describing the current flow through the device is measured during one operating state of the device.

In yet another method step 103, the operating temperature of the device is ascertained using the first value, the specified initial temperature, and the second value.

Setting of a value is understood to mean that this value is used as a basis for the further method steps. This may be achieved, for example, by measuring the value beforehand, but also by reading out a value that has been input into a memory. In addition, the value may also be supplied by other devices.

The operating temperature is understood to be the temperature of the device during operation of the vehicle, regardless of whether the device is itself being actively operated at the time the temperature determination is made.

The first and the second value of the same electrical quantity are preferably determined during implementation of the method according to the present invention. This means that in each of the method steps in question, voltages, currents, resistances or the like are measured.

The operating temperature is preferably determined using a characteristic material parameter. A characteristic material parameter is understood to be a characteristic parameter which describes at least one physical property of the material that makes up those components of the device being examined which participate in the current flow. The characteristic material parameter is preferably temperature coefficient a of the material.

In one preferred specific embodiment, the electrically operated device is an electric motor. However, it may also be applied to other components of the active chain of an actuator control, for example to other actuator motors or to the control unit.

In another method step, the quantity describing the current flow through the device may be selected from a group of quantities, which includes the voltage present at the device, the current flowing through the device and, in particular, the electrical resistance of the device. It should be noted in this context that the quantities mentioned are correlated with one another, so that individual quantities may be indirectly determined, such as the resistance from the relationship between the applied voltage and the flowing current.

The electrical resistance of the device is preferably determined as a quantity.

In addition, the initial temperature is preferably determined from a group of temperatures, which includes the cooling-water temperature, the transmission-fluid temperature, the ambient-air temperature, the pcb temperature of the control unit and/or the like.

Arithmetic averaging methods may be used to determine the initial temperature from a group of temperatures, including the cooling-water temperature, the transmission-fluid temperature, the ambient-air temperature, the pcb (printed circuit board) temperature of the control unit and/or the like. When carrying out these arithmetic averaging methods, weighting operations may also be performed, i.e., in that individual temperatures are given greater consideration than others. This makes it possible to take into account that some components of a motor vehicle cool at a considerably slower rate than others.

In addition, it is possible to hold off on determining the initial temperature until the mentioned temperatures are at a substantially same level. This is the case, for example, when the vehicle has not been operated for an extended period of time. In such a case, there is no need to determine a plurality of different temperatures. A specific temperature, such as the cooling-water temperature, may be selected as the initial temperature, since it may be assumed that the remaining temperatures correspond to the cooling-water temperature.

From the initial temperature, which, at the same time, represents the initial temperature of the operated device, the quantity describing the current flow through the device may be inferred, this quantity, as described above, preferably being the resistance of the device.

The first electrical quantity describing the current flow through the device is preferably determined from predefined data characterizing the device.

This resistance value is preferably determined from predefined data, for instance from the values at room temperature, as provided on the electric motor's specification sheet. In this context, resistance Rₛₜₐᵣₜ of the motor is derived in accordance with the following equation:
R(T)=Rₛₜₐᵣₜ·(1+α(T−Tₛₜₐᵣₜ)) (1)

Here, Rₛₜₐᵣₜ denotes the resistance value of the motor to be determined at temperature Tₛₜₐᵣₜ ascertained above. R₀ denotes the resistance at room temperature T₀, the room temperature being 25° Celsius, for example.

Generally, the following equation holds for the relationship between the temperature and resistance:
Rₛₜₐᵣₜ=R₀(1+α(Tₛₜₐᵣₜ−T₀)) (2)

From equations (1) and (2), a linear dependency is obtained for the dependency of the resistance on the temperature. This linear dependency is based on a linear relationship existing between temperature and resistance, as a function of temperature coefficient α. Thus, given a known temperature Tₛₜₐᵣₜ and temperature coefficient α, i.e., the linearity factor between the resistance and the temperature, it is possible to calculate resistance Rₛₜₐᵣₜ. In the case of the copper preferably used for motors, temperature coefficient α is 0.004 K⁻¹.

The resistance of the copper and the linear relationship between its resistance and temperature change only insignificantly over the lifetime of the devices in question. Therefore, in the context of a permanently defined combination of control unit, drive electronics and electric motor, initialization values Tₛₜₐᵣₜ and Rₛₜₐᵣₜ can be ascertained at least once and be used as a basis for the calculations mentioned above.

The values for temperature Tₛₜₐᵣₜ and resistance Rₛₜₐᵣₜ are preferably measured once, for example at initial start-up of the motor vehicle. A measuring operation is preferably repeated in the event that individual components of the device or its peripherals are replaced.

Values Rₛₜₐᵣₜ and Tₛₜₐᵣₜ computed by the above equations or ascertained from measurements are preferably stored in a memory device, such as preferably in an EEPROM of the control unit, in order to be able to subsequently determine the actual motor temperature.

As noted above, this first determination of Rₛₜₐᵣₜ and Tₛₜₐᵣₜ i.e., this initialization only needs to be carried out once over the lifetime of the components involved. It is also preferably possible for this initialization to always be performed when the mentioned conditions are met, i.e., when temperature Tₛₜₐᵣₜ can be determined, for example following a relatively long rest period of the motor vehicle. In this context, it is also only possible for the initialization to be performed at start-up of the vehicle during production and in the event that individual components are replaced in a service station.

In another preferred variant, the first electrical quantity describing the current flow through the device is measured by measuring the current flowing through the device and the voltage present at the device.

The first electrical quantity describing the current flow through the device is measured by measuring the battery voltage and the battery current. By measuring value Rₛₜₐᵣₜ in this manner, this value may be ascertained by measuring operations independently of quantity Rₛₜₐᵣₜ determined by solving the equation. In this context, the measuring process and the equation-computed determination may be carried out independently of one another, however, the measurement of value Rₛₜₐᵣₜ may also be compared to calculated value Rₛₜₐᵣₜ.

If a comparison of these two values reveals that they are comparable within a predefined tolerance, then it may be inferred that the motor and the components whose temperature values are available, were in thermal equilibrium.

In addition, any given arithmetic mean values may also be used from the measured value and from value Rₛₜₐᵣₜ calculated using formulas (1) and (2), by applying any given weighting operations, it being possible to allow for any possible measuring inaccuracy or imprecise mathematical determination.

In one preferred variant, value R_{start,meas} is measured as a function of a measurement of motor voltage Uₘₒₜₒᵣ and of motor current Iₘₒₜₒᵣ. In this case, measured resistance Rₛₜₐᵣₜ is derived in accordance with the following equation:
R_{start,meas}=Uₘₒₜₒᵣ/Iₘₒₜₒᵣ (3)

Alternatively, it is also possible to determine the total resistance of all of the components involved, i.e., of the motor, the drive electronics and the like, total resistance Rₜₒₜ being obtained in accordance with the following equation:
Rₜₒₜ=U_{batt}/I_{batt} (4)

In equation (4), U_{batt} denotes the battery voltage and I_{batt} the battery current.

In order to calculate above value R_{start,meas} from ascertained total resistance Rₜₒₜ, all losses of the total active chain and possibly even the physical equations that govern the electric motor and the drive electronics are used.

It is preferably possible here as well to determine the total resistance and the above R_{start,meas} and to compute a value for a resistance using suitable arithmetic determinations.

Preferably, the second electrical quantity describing the current flow through the device is measured in a plurality of processes, and a mean value is calculated from the measured values using predefined arithmetic methods.

On the basis of the thus ascertained, measured and calculated values, the actual motor temperature may now be determined at any given time, by using the following equation as a basis, which is derived by mathematically rearranging the equations named under (1) and (2):

$$T = \frac{1}{α} ( \frac{R ( T )}{{R}_{start}} - 1 ) + {T}_{start} \qquad ( 5 )$$

In equation (5), T denotes the temperature to be determined, a the temperature coefficient, R(T) the resistance of the motor at temperature T, Rₛₜₐᵣₜ the above initialization resistance value, and Tₛₜₐᵣₜ the initialization temperature. Value R(T) is determined using the methods mentioned above, by applying formula (3) or (4).

The temperature is preferably checked at regular intervals throughout the course of the entire operation. In another preferred variant, the temperature is ascertained continuously or non-intermittently. It is preferably possible as well for a warning signal to be emitted when a specified limiting temperature is reached or exceeded, or for the voltage supply to the motor in question to be cut off in response to a further increase.

In another preferred variant, the frequency of the temperature measurements may be adapted to the temperature measured at any one time. Thus, the frequency of the measurements may be increased in response to a rising temperature or in response to a temperature above a predefined limiting value.

As mentioned at the outset, the method according to the present invention may also be applied to all other components of the active chain of the actuator control. It is generally possible for the method according to the present invention to be applied to electrically operated devices.

Since, as mentioned, initial temperature Tₛₜₐᵣₜ is also important for the accuracy of the device temperatures ascertained in each case, it should be noted with regard to the accuracy of the entire measurement that the temperature may also be measured within the tolerance limits of the available temperatures, so that the final measurement of the operating temperatures is thus also subject to certain fluctuations. For this reason, as mentioned at the outset, it is advantageous for a plurality of temperature measurements to be taken at different points of the circuit, such as the ambient-air temperatures, the pcb temperatures, or the cooling-water temperature, and to calculate mean values from these values. Also, only a limited accuracy can be achieved when determining the individual resistances. For that reason, it is also advantageous to measure the resistances in question in different ways, and to calculate plausible mean values from these measurements.

As mentioned, it is especially significant for the method according to the present invention that the relationship between temperature and resistance in the case of copper is substantially linear. The fact that this linear characteristic exists, is utilized in particular in the mentioned range of 0 to 150° Celsius relevant to the present invention.

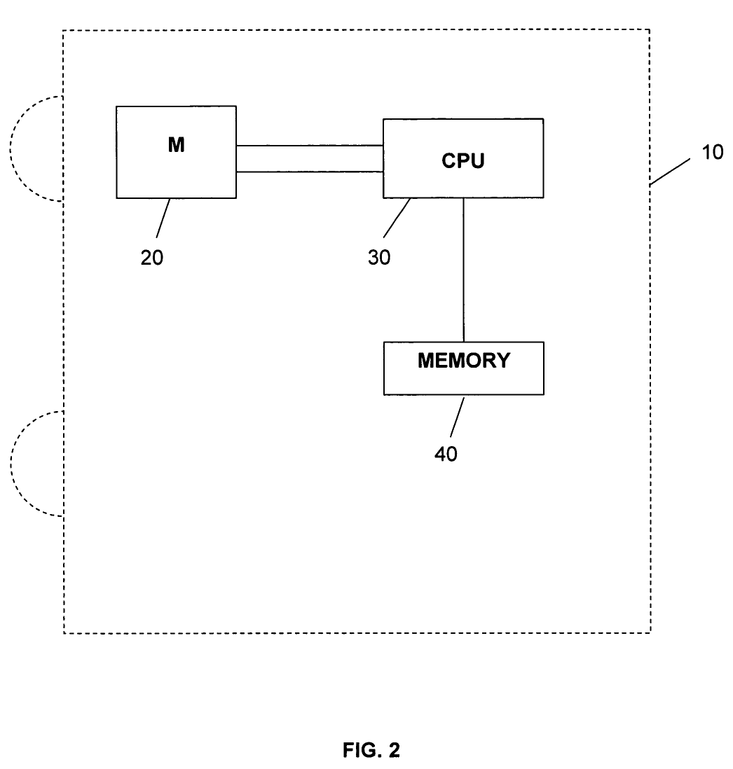

FIG. 2 shows a system for determining an operating temperature of electrically operated devices such as an electric motor 20 in a motor vehicle 10, having a processor unit 30 which is set up in a way that enables at least one first value of an electrical quantity describing the current flow through the device to be set at the specified initial temperature; and a second value of an electrical quantity describing the current flow through the device to be measured during one operating state of the device; and finally, in such a way that the operating temperature of the device is ascertained using the first value, the specified initial temperature, and the second value. In the preferred specific embodiment, the processor unit according to the present invention also has a memory unit 40, in which the value of the specified initial temperature, as well as the first value of the quantity describing the current flow through the device are stored.

In this context, the processor unit preferably determines the operating temperature of the electrically operated device by applying equation (5).

What is claimed is:

1. A method for determining an operating temperature of an electrically operated device in a motor vehicle, comprising the steps of:
providing at least one first value of an initial electrical quantity describing the current flow through the device at a specified initial temperature;
measuring a second value of an operating electrical quantity describing the current flow through the device during one operating state of the device;
ascertaining the operating temperature of the device as a function of the first value, the specified initial temperature, and the second value.

2. The method as recited in claim 1 wherein the electrically operated device is an electric motor.

3. The method as recited in claim 1 wherein the first value and the second value describe the same type of electrical quantity.

4. The method as recited in claim 1 wherein the operating temperature is determined using a characteristic material parameter.

5. The method as recited in claim 1 wherein the operating quantity describing the current flow is selected from at least one type of quantities including voltage present at the device, current flowing through the device and electrical resistance of the device.

6. The method as recited in claim 1 wherein the initial temperature is determined from at least one of the cooling-water temperature, the transmission-fluid temperature, the ambient-air temperature and the pcb temperature of the control unit.

7. The method as recited in claim 1 wherein arithmetic averaging methods are used to determine the initial temperature from at least two of thwe following: the cooling-water temperature, the transmission-fluid temperature, the ambient-air temperature, and the pcb temperature of the control unit.

8. The method as recited in claim 1 wherein the value of the specified initial temperature is stored in a memory.

9. The method as recited in claim 1 wherein the first value is stored in a memory.

10. The method as recited in claims I wherein the initial electrical quantity describing the current flow through the device is determined from predefined data records characterizing the device.

11. The method as recited in claim 1 wherein the inital electrical quantity describing the current flow through the device is measured by measuring the current flowing through the device and the voltage present at the device.

12. The method as recited in claim 1 wherein the initial electrical quantity describing the current flow through the device is measured by measuring the battery voltage and the battery current.

13. The method as recited in claim 1 wherein a first initial electrical quantity describing the current flow through the device is determined from predefined data records, and a second intial electrical quantity describing the device is measured, and the first and second intitial electrical quantities are compared to one another.

14. The method as recited in claim 1 wherein the operating electrical quantity describing the current flow through the device is measured by measuring the current flowing through the device and the voltage present at the device.

15. The method as recited in claim 1 wherein the operating electrical quantity describing the current flow through the device is measured by measuring the battery voltage and the battery current.

16. The method as recited in claim 1 wherein the operating electrical quantity describing the current flow through the device is measured in a plurality of processes, and a mean value is calculated from the measured values using predefined arithmetic methods.

17. A system for determining an operating temperature of an electrically operated device in a motor vehicle, the system comprising:
a processor unit performing the following steps:
providing at least one first value of an initial electrical quantity describing the current flow through the device at the specified initial temperature;
measuring a second value of an operating electrical quantity describing the current flow through the device during one operating state of the device; and
ascertaining the operating temperature of the device as a function of the first value, the specified initial temperature, and the second value.
